(19) United States
(12) Patent Application Publication
(10) Pub. No.: US 2021/0047211 A1
(43) Pub. Date: Feb. 18, 2021

(54) SEPTIC TANK TREATMENT SYSTEM

(71) Applicants: Charles Otis, MIlwaukee, WI (US); Brian Van Roy, Sarasot, FL (US)

(72) Inventors: Charles Otis, MIlwaukee, WI (US); Brian Van Roy, Sarasot, FL (US)

(21) Appl. No.: 16/995,118

(22) Filed: Aug. 17, 2020

Related U.S. Application Data
(60) Provisional application No. 62/888,110, filed on Aug. 16, 2019.

(51) Int. Cl. C02F 1/72; C02F 1/00; C02F 11/06

(52) U.S. Cl. CPC C02F 1/727; C02F 2103/007; C02F 11/06; C02F 1/008

(57) ABSTRACT

A system for wastewater treatment includes a container placeable in the fluid within a wastewater treatment vessel. The container comprises an inlet into which fluid from the treatment vessel can flow. In operation, compressed air is provided to aerate fluid within the container and vented from the container in such a way that fluid in the vessel external to the container does not receive aeration. Substrate within the container provides biomedia for treating wastewater. The user controls the operation of a pump that transports fluid from inside the container into fluid in the vessel external to the container. Concomitantly, fluid from outside the container flows in though the container's inlet. Thereby, the system continuously treats wastewater with aeration, intermixing treated and untreated wastewater.

### CROSS-REFERENCE TO RELATED APPLICATION

This application claims the benefit of U.S. provisional patent application No. 62/888,110, filed Aug. 16, 2019.

### BACKGROUND OF THE INVENTION

### Field of the Invention

This invention relates generally to a wastewater treatment system. More particularly, this invention relates to a wastewater treatment system for a septic tank, cesspool, lagoon, pond or other body of fluid to reduce organic and nutrient contaminants from the body of fluid.

### Description of the Related Art

Wastewater from residential or commercial activities is generally treated to remove undesirable pollutants. The processed water can then be returned to the environment for future use or disposal. The wastewater treatment process typically includes three general phases. The first phase, or primary treatment, typically involves separating solids from the wastewater typically done in sedimentation tanks with the help of gravity. The second phase, or secondary treatment, involves the biological oxidation of carbonaceous and nutrient material in the wastewater to more environmentally friendly forms. This is typically done by promoting the consumption of the carbonaceous and nutrient material by providing oxygen to bacteria and other types of beneficial organisms already present in the wastewater or by addition to the wastewater. The third phase, or tertiary treatment, involves removing the remaining pollutant material from the wastewater. This is typically done by filtration and/or the addition of chemicals, UV light or Ozone to neutralize harmful organisms and pollutant material.

The focus of this invention is in the second phase of the wastewater treatment process, which typically includes an aerobic—with oxygen—portion in which bacterial and other microorganisms are provided dissolved oxygen to promote their consumption of carbonaceous and nutrient compounds. In advanced treatment systems, such as those designed to reduce nitrogen, aerobic zones are paired with anoxic zones. In anoxic zones the electron acceptor, which is typically oxygen in aerobic zones, is provided from a nitrate/nitrite source when there is low or no dissolved oxygen—where bacteria and other microorganisms unpreferentially or facultatively use oxygen in the nitrate/nitrite form for their metabolic functions. In other advanced treatment systems, the secondary treatment phase may also include an anaerobic—without oxygen of any type—portion in which bacteria and other microorganisms metabolically function without oxygen, often called fermentation or anaerobic digestion.

In the aerobic portion of the second phase of wastewater treatment, wastewater that includes ammonium (NH4) and organic waste containing nitrogen, for example urea ((NH2)2CO), or proteins, is provided with dissolved oxygen. In the presence of dissolved oxygen (O2), bacteria convert (oxidize) the ammonium into nitrate (NO3-) via nitrite (NO2-). In the presence of denitrifying bacteria and low dissolved oxygen, nitrate can be anoxically processed into nitrogen gas (N2), which is harmless in the environment and not soluble in water. This portion of treatment takes place both in an aerobic zone and anoxic zone in a wastewater treatment system where water is recycled between zones.

In the aerobic zone, a blower and diffusers supply dissolved oxygen to the wastewater. The blower provides air to diffusers, and the diffusers release tiny bubbles that rise to the surface and transfer oxygen to the wastewater by diffusion. As the aerobic process progresses, carbonaceous compounds and ammonium in the wastewater become oxidized and covert the nitrogenous compounds to nitrite and nitrate, increasing their respective dissolved concentration in the wastewater. When the nitrogenous compounds are converted to nitrate, this nitrate can be non-preferentially used by bacteria for respiration in a low dissolved oxygen environment with available carbonaceous compounds, as preferentially oxygen would be used for respiration.

In an anoxic process, wastewater that includes nitrate and dissolved oxygen enters an anoxic zone, which typically contains high concentrations of unoxidized carbonaceous compounds. The oxygen in the aerobically treated wastewater is almost immediately consumed in the absence of aeration of the anoxic zone, and in the absence of dissolved oxygen, bacteria use nitrate (NO3-) as an electron acceptor instead of oxygen when consuming carbonaceous compounds, expelling nitrogen gas (N2) that makes its way to the atmosphere. This process is known in the art as denitrification. As the anoxic process progresses, nitrate is consumed and the concentration decreases in the wastewater, effectively removing nitrogen from liquid phase.

Exemplary of the prior art, U.S. Pat. No. 4,793,929 to Kickuth et al., discloses a system in which sewage water is caused to react with atmospheric oxygen to oxidize ammonia in the sewage water to nitrate in a first purification stage (nitrification). In a second subsequent purification stage, which contains areas rich in atmospheric oxygen and areas poor in atmospheric oxygen, the nitrate formed in the first purification stage is converted to nitrogen gas (denitrification). Kickuth's system employs an aerated fluid treatment pond and a fixed or gravel bed planted with helophytes or limnophytes such as disclosed in European patent number 0028360.

Conducting nitrification and denitrification in a single treatment vessel, be it cesspool, lagoon, treatment pond, or septic tank, may be desirable in a number of circumstances. As a case in point, many domestic septic systems comprise of only one tank. Typically, in these systems only basic solids separation and some fermentation reactions occur. In particular with septic tanks, much of the aerobic treatment is left for the drainfield, in which soil bacteria consume the mostly dissolved carbonaceous compounds and nitrogenous compounds (nitrification). If carbon is present in the soil, it is possible to have some denitrification deep the drainfield where there is a dearth of oxygen, however, often only partial denitrification occurs and nitrate flows into groundwater without being converted to nitrogen gas. For users of such systems, more effective treatment of wastewater in a single tank may have the desirable result of producing cleaner effluent wastewater for the septic drain field and removal of nitrogen compounds prior to this step. A number of approaches have been taken in the prior art to provide a means to retrofit an existing septic tank to in order to afford improved wastewater processing.

As an example in which a single tank is outfitted to provide an isolated aerobic zone, in U.S. patent application publication number 20030066790, Ribori describes a collapsible reactor module that is capable of being folded to pass through the opening in the cover of a septic tank and unfolded to provide a reactor chamber supported within the septic tank. Media containing microorganisms is disposed within the chamber. A blower device feeds air to an aerator located within the reactor module. The operation of Ribori's system depends on a circulation of wastewater from the tank and within the reactor module in response to convection currents induced by the bubbles produced by the aerator. The mixing between aerobically nitrified liquid with liquid in anoxic zones results in effective wastewater digestion. Accordingly, Ribori mixes the nitrified liquid in his module with liquid in anoxic zones in the tank outside of the module to digest the nitrogen in the septic tank wastewater. A limitation of his approach is that the mixing between aerobic and anoxic zones in his system is not subject to proper control, resulting in an inefficiency in the digestion process.

By way of another example of a system in which a septic tank is retrofitted to enhance the efficacy of wastewater digestion, Drewery et al. in U.S. patent application publication number 2040/0071216 describe a collapsible clarifier that folds to pass through the opening of a septic tank. When opened within the tank, the clarifier provides a zone somewhat isolated from suspended solids in the wastewater. The tank is also provided with a blower-fed aerator, located in the tank outside the clarifier. The clarifier thus effectively serves to provide an anoxic zone complementing the aerobic zone that is oxygenated by the aerator outside the clarifier. Anoxically treated fluid, relatively free of suspended solids, may be drawn from the interior of the clarifier as effluent from the Drewery septic system. This system, relying upon incidental aerator convection current to mix the wastewater, has an inefficiency similar to that of Ribori's system described above.

What is needed is a system affording wastewater treatment in a single treatment vessel, such as a cesspool, lagoon, treatment pond or septic tank, with enhanced efficiency. What is needed further is such a system that enhances efficiency by providing both nitrification and denitrification of wastewater. Further still, what is needed is a system that enables adjustment of the flow of treatment liquid between aerobic and anoxic treatment zones. Yet further, what is needed are embodiments of such a system that enable the easy retrofit of existing treatment vessels having small access openings, such as is typical in septic tanks. Additionally what is needed is a system that can provide an ample amount of biological material to adequately process the wastewater.

### SUMMARY OF THE INVENTION

A wastewater treatment system comprises a wastewater vessel such as a septic tank, having an influent inlet and at least one effluent outlet. Disposed within the vessel is an aerobic treatment unit, positioned with respect to fluid in the vessel as further described below. Notably, embodiments of the aerobic treatment unit can be dimensioned to enable retrofit of the system to existing septic tanks and cesspools.

Embodiments of the unit comprise a container having a top and a bottom. In the side of the unit, below the top of the unit and substantially above its bottom, are one or more side openings through the container wall, the openings comprising a fluid inlet. Embodiments further comprise a vent to release gas on the top of the container. Some embodiments of the aerobic treatment unit contain physical substrate comprising biomedia, the substrate having a large surface area to promote the growth of digestive microorganisms. In some such embodiments, the substrate is restrained inside the aerobic treatment unit by physical adhesion to the unit interior or by sieve action at the container fluid inlet and vent. Disposed within the aerobic treatment unit near its bottom is a diffuser receiving pressurized air from a blower, the blower in some embodiments external to the unit.

Further disposed within the unit near its bottom is pump with controllable rate of operation. In some embodiments, the pump may be an air operated pump such as a bubble generator or pulsed air pump operatively and controllably connected to a source of pressurized gas. In some embodiments with an air operated pump, the external blower for the diffuser may, in addition, be controllably connected to the pump as its source of compressed gas. The pump comprises a fluid inlet, the inlet receiving fluid from inside the unit and screened in embodiments where required to retain biomedia substrate within the unit. The pump further comprises a pump outlet, the pump outlet connected to a fluid conduit leading upward through the unit and terminating in a unit outlet near the top of the unit.

In system operation, the wastewater treatment vessel is partially filled through its influent inlet to a normal operational level with wastewater fluid to be treated, leaving a headspace above the surface of the fluid. As installed in the vessel, the aerobic treatment unit is secured in a position in which, when the vessel is filled with fluid to the normal level, the vent at the top of the unit opens into headspace above the surface of the fluid and the side openings of the unit are immersed in the fluid. Embodiments of the invention permit adjusting the height at which the unit is positioned in the vessel in order to so align the unit with respect to the normal operational level of fluid in the unit. Means for adjusting the height of the unit in such embodiments include telescoping assemblies, cog and chain, ratchet or such other means well known to those in the mechanical arts.

Operationally, fluid from the vessel enters the unit through the unit's side openings. The blower provides compressed air to the unit's diffuser to saturate the fluid inside the container with oxygen. Advantageously, fluid outside the unit is not oxygenated by the diffuser. Within the unit, microbes, which in some embodiments may adhere to physical substrate, utilize oxygen to oxidize carbonaceous compounds and nitrify the fluid within the unit. Meanwhile, because the fluid exterior to the unit is not oxygenated and has relatively constant influent of new unoxidized carbonaceous compounds, microorganisms in the vessel outside the unit can conduct anoxic denitrification of the exterior fluid.

When the pump is operated, fluid within the unit is drawn in through the pump inlet and pumped out of the pump outlet through the fluid conduit to the unit outlet, where the fluid from the unit flows into fluid in the vessel exterior to the unit. Thereby, nitrified fluid from inside the unit is mixed into fluid in the anoxic environment exterior to the unit for denitrification. Concomitantly, the pumping of nitrified fluid out of the unit necessarily results in a flow of fluid into the unit from the unit's exterior through the unit's side openings. Thereby fluid from outside the unit is mixed into the fluid inside the unit for oxygenation and nitrification. By controlling the operation of the pump, either by varying pump flow rate or duty cycle, control is exercised over the rate of exchange of nitrified fluid from the unit with the anoxic fluid in the vessel exterior to the unit. The user may thereby exercise control over the aerobic digestive process within the vessel, optimizing treatment of water in the vessel for dispersal from the vessel effluent outlet.

### BRIEF DESCRIPTION OF THE DRAWINGS

Objects of the present invention as well as advantages, features and characteristics, in addition to methods of operation, function of related elements of structure, and the combination of parts and economies of manufacture, will become apparent upon consideration of the following description and claims with reference to the accompanying drawings, all of which form a part of this specification, wherein like reference numerals designate corresponding parts in the various figures, and wherein:

FIG. 1 is a schematic of the aerobic treatment unit disposed within a wastewater treatment vessel in one embodiment of the system and

FIG. 2 is a schematic of an aerobic treatment unit according to an embodiment of the invention.

### DETAILED DESCRIPTION OF THE INVENTION

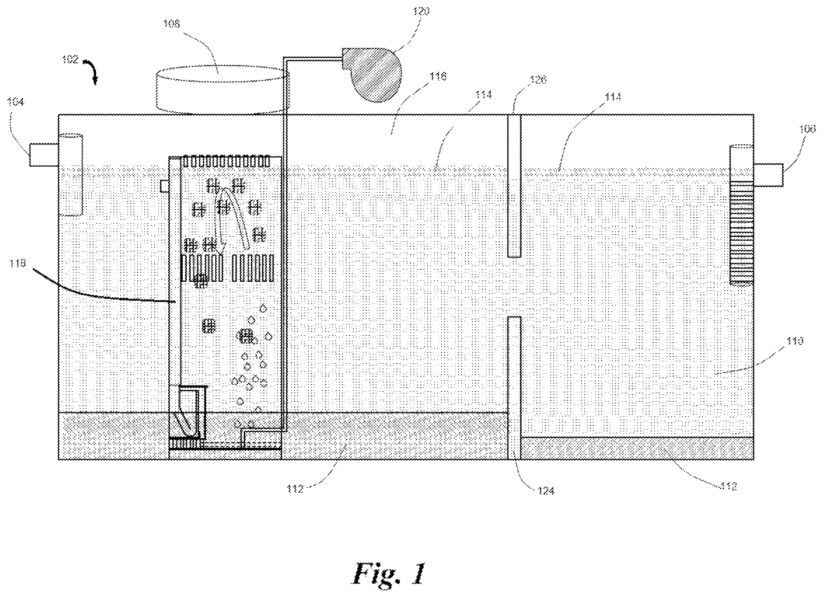

Turning now to the drawings, FIG. 1 depicts a schematic of the aerobic treatment unit disposed within a wastewater treatment vessel in one embodiment of the system. As depicted, vessel 102 is a tank such as a cesspool or septic tank. Conceptually, embodiments of vessel 102 may also be a lagoon, a treatment pond or any other container employed for wastewater treatment. As depicted, vessel 102 comprises an inlet 104, an outlet 106 and an access opening 108. Vessel 102 is partially filled with waste fluid 110 to be treated, the fluid 110 as depicted further comprising sedimentary sludge 112 at its bottom and floating scum 114 on its surface. Above the surface of fluid 110 is headspace 116.

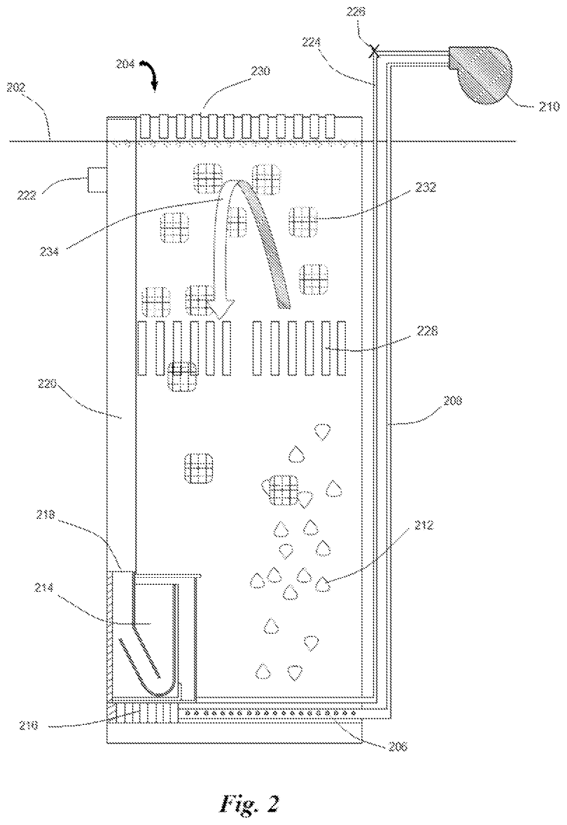

Disposed within vessel 102, proximal inlet 104 is aerobic treatment unit 118, the bottom thereof as depicted resting on or near the bottom of vessel 102 and the top thereof protruding above the surface of the fluid 110 into the fluid headspace 116. As depicted, an external blower 120 operatively connects to aerobic unit 118 to supply air to diffusers in unit 118 as described further in reference to FIG. 2 below.

The volume of fluid 110 outside of aerobic treatment unit 118 comprises an anoxic mixing zone 122. In the depicted embodiment, lower wall 124 and upper wall 126 divide anoxic mixing zone 122 into clarifying section 128 proximal inlet 104, and clarified section 130 proximal outlet 106. As depicted, lower wall 124 serves to retain some of sludge 112 in clarifying section 128, away from clarified section 130. Similarly, as further depicted, upper wall 126 serves to retain some of scum 114 in clarifying section 128, away from clarified section 130.

Advantageously, embodiments of the invention fashion aerobic treatment unit 118 in form and dimension so that it can fit through opening 108, thereby permitting the retrofit of an existing wastewater treatment container, such as the embodiment depicted as vessel 102, with the system of the present invention.

Turning to FIG. 2, depicted is a detailed schematic of an embodiment of the aerobic treatment unit as disposed within a fluid treatment vessel filled to a normal level 202 with wastewater fluid undergoing treatment. In the depicted embodiment, partially immersed in the treatment fluid and secured within the vessel (positioned as described below) is aerobic treatment unit 204. In this embodiment, unit 204 is a rectangular box near the bottom of which is disposed an oxygen diffuser 206 connected via air supply line 208 to an external blower 210. Blower 210 provides air under pressure to diffuser 206 in order to form oxygenating bubbles 212 that rise through fluid in the aerobic treatment unit 204 but are not dispersed into fluid external to the unit.

Further disposed within unit 204 is pump 214, as depicted having pump inlet 216 and pump outlet 218 connected to fluid conduit 220 leading to unit outlet 222. Embodiments of the invention may use an air driven pump. For such embodiments, the unit 204 includes a controllable pump air supply line 224. In the depicted embodiment, pump air supply line 224 receives air from blower 210 under the control of user control valve 226. Other means of control of air supplied in embodiments utilizing an air pump may comprise orifice plates in the supply line, proportionally limiting air flow. Other embodiments in which an air driven pump is used may employ a separate controllable source of compressed air. Yet other embodiments of the invention may employ a form of user controlled pump other than one which is air driven, such as an electrical pump for which electrical energy under user control is supplied.

Side openings 228 are cut through the wall of the aerobic treatment unit 204 at a point near midway between the bottom and the top of unit 204. Through the top of unit 204 is vent 230. Unit 204 is secured within the vessel at a level so that vent 230 is above the surface level 202 of the wastewater fluid, and side openings 228 are immersed in wastewater fluid, Thereby, all air and other gasses escape from unit 204 through vent 230 into the headspace above the level 202 of the fluid within the vessel, avoiding aeration of the fluid outside the vessel, and fluid can flow through side openings 228 from the exterior of unit 204 into the interior of the unit.

In the depicted embodiment, disposed within unit 204 are floating biomedia 232 having a large surface area to promote the growth of digestive microorganisms. As depicted, biomedia 232 are loose high-surface area plastic pieces that can move about in fluid within unit 204, propelled by convection currents 234 (shown as a curved arrow), resulting from the diffusion of bubbles 212 from diffuser 206. In the depicted embodiment, biomedia 232 are too large to pass through side openings 228 and so are retained within the interior of unit 204. Further, as depicted pump inlet 216 and unit vent 230 are fitted with screens to retain biomedia 232 within the unit. In other embodiments, biomedia 232 may comprise substrate material that is fixed to the interior of unit 204 and thereby retained within it.

In operation, aerating bubbles 212 are continuously supplied by diffuser 206, thereby aerating fluid and creating an aerobic zone within unit 204, supporting biological nitrification therein. Because aeration in the system is contained in unit 204 and vented only through vent 230 into headspace above the level 202 of the wastewater, the aerobic zone within unit 204 is isolated and fluid external to unit 204 is in an effective anoxic zone.

Under user control, nitrified fluid from the aerobic zone within unit 204 is pumped out of the unit by pump 214 though screened pump inlet 216. In the depicted embodiment, pump inlet 216 is advantageously located near the bottom of unit 204, resulting in pumping of settled solids and sloughed of microorganisms along with fluid from inside the unit. In any case, fluid is pumped out of unit 204 via conduit 220 and unit outlet 222 into fluid in the anoxic zone external to the unit, where microorganisms therein can denitrify the fluid. The displacement caused by pumping the fluid from the interior of the unit results in fluid from the anoxic zone exterior to the unit to be drawn into the unit through side openings 228 for aeration and nitrification within the unit.

Embodiments provide a means for the user to control the rate of mixing aerobic with anoxic fluids. In some embodiments, the user controls the rate controlling the flow rate of pump 214. In other embodiments, the user exercises control over the rate of mixing by controlling the duty cycle of pump 214. Yet other embodiments may employ a combination of flow rate and duty cycle control. In any case, by affording control over the rate of mixing of fluid between the aerobic and anoxic zones, the system enables the user to exercise fine control over the rate and efficacy of wastewater treatment by the system.

Turning now to materials of construction and methods of manufacture of the aerobic treatment unit, in some embodiments of the container comprising the unit, all construction is made with flat sheet material, enabling ease of manufacture and assembly of parts on site. The unassembled container parts are stackable, taking up little space. Pieces may be fashioned to fit together with slots and tabs, using a minimal amount of screws, rivets, adhesive, or other fastener. Parts that need sealing can be sealed using adhesives particular to the material or other adhesive agents.

For embodiments intended to retrofit existing vessels closed with an opening such as septic tanks or cesspools, the unit container is dimensioned to fit through the access opening in the vessel. A common access opening diameter is 24 inches and for vessels with such openings the least dimension of the unit is less than 24 inches, in some embodiments 20 to 23 inches. In applications in which the opening is greater than 24 inches, the least dimension of the unit may be more than 24 inches but less than the diameter of the access opening. In applications where the vessel is not closed but is open, such as a treatment lagoon, the unit may be scaled as large as desired for the treatment of larger quantities of fluid. The overall dimensions of a unit are determined by the dimensions is required to support the larger volume of microorganisms required to process a larger volume of waste fluid. Requirements will vary depending upon the optimal rate of throughput for the system and the form of physical substrate provided within the unit for bacterial growth, as discussed further below.

Aerators appropriate for operation of the unit are well known to those in the art. Such an aerator may comprise simply apertures in a pipe or it may be a specially designed header such as those available in a wide variety of forms for creating the desired bubble size. Bubbles for aerating fluid in the unit may be small, having a diameter of 3 mm or less, or coarse, ranging from 3 to 50 mm in size. While smaller bubbles can be more effective in aerating the fluid, owing to a greater surface area to volume ratio, production of coarse bubbles may be more reliable, the diffusers for such purpose less prone to clogging. In any case, what is needed is an aerator that provides sufficient aeration so that the fluid in the container is oxygenated for processing as described above. The blower providing air to aerator is of a conventional sort well known in the art, such as a positive displacement blower of appropriate capacity from Republic Manufacturing of Dallas, Tex.

As discussed previously, microorganisms within the unit utilize oxygen supplied by the aerator to oxidize and nitrify the wastewater within the unit. Efficiency of microbial growth and digestion is optimized when a physical substrate is provided, the substrate comprising a large surface area for microbial growth in the form of biofilm. For effective operation, a large surface area of substrate is required, in some embodiments comprising an area on the order of 200 square feet of surface area per cubic foot of media/substrate within the unit. In embodiments, the substrate may comprise particles of sponge, plastic, or other biofilm carrier elements which are moved about the unit by convection currents in the fluid. Such a substrate is known in the art as a moving bed bioreactor (MBBR). As is well-known to those in the art, an estimate can be made of the amount of substrate surface area needed to meet a given wastewater treatment requirement. For example, to reduce biological oxygen demand and nitrify the typical wastewater of a family of 6 people in 12 hours, roughly 1000 square feet of substrate surface may be required. Effective embodiments of the treatment unit that use MBBR may be filled up to 75% of their total volume with the required amount of MBBR elements, thereby determining overall requirements for dimensions of the unit. Similar analysis can be employed to determine dimensions for units using IFAS or other substrate technologies. In any case, what is needed is for microbial growth and activity within the unit to be cultivated and promoted by use of physical substrate in one or another form well known to those in the art, and for the unit to be configured and dimensioned to accommodate the surface area of substrate required for optimal operation.

The unit pump may be air driven. Among air driven pumps available are pulsed air pumps such as the Megabubble™ pulsed air pump manufactured by Pulsed Burst Systems LLC of Richfield, Wis. Air pumps are widely used in wastewater treatment applications because they are resistant to clogging by sludge and other solids present in wastewater and in fact can serve to transport such materials. These sorts of air pumps are further often preferred in waste treatment applications because there are no mechanical or electrical parts to maintain and because pump operation generally does not, in itself, significantly aerate the fluid. Alternatively, the unit pump may be electrically, hydraulically or pneumatically driven. Because of the presence of solids and sludge within the unit, the pump employed should be appropriate for moving fluid with solids and semi-solids in waste liquids. In any case, though, what is needed for operation of the invention is that the operation of the pump may be adjusted by the user to control the rate of flow of treatment fluid through the unit.

While a benefit of operation of the pump is pumping treated fluid from within the unit to mix with fluid in the vessel outside the fluid and thereby drawing fluid from outside the unit into the unit, embodiments in which the pump is also operational to pump sludge and other solid material out of the unit have additional utility. Such embodiments assure that sludge and solids do not accumulate in excess within the unit. Further, causing the circulation of sludge in the vessel fosters the overall treatment of the wastewater. Embodiments using pumps that in operation intermittently transfer large volumes, such as an intermittent air pump, may be particularly effective in this regard.

Although embodiments of the invention have been described above, persons of skill in the art will appreciate that variations and elaborations of the system may be made that are nonetheless within the scope of the invention. All such embodiments are contemplated by the present invention. For example, in a vessel divided into a clarifying section and a clarified section such as depicted in FIG. 1, placement of an aerobic treatment unit in one of the sections may be more effective for wastewater treatment than placement in the other section. In other embodiments, an aerobic treatment unit may be placed in each section, the pumping of each unit adjusted so that BOD digestion is optimized in the unit in the clarifying section (normally proximate the vessel's inlet) and nitrification is optimized in the unit in the clarified section. (normally proximate the vessel's outlet).

In other embodiments of the system, an aerobic treatment unit may have a partition separating the treatment unit into two sections, each of which is aerated with compressed air that is vented without aerating fluid external to the treatment unit. A fluid inlet in the first section allows fluid from the vessel's exterior to flow into the first section. An adjustable pump moves fluid from the second section into the fluid in the vessel exterior to the treatment unit. The partition permits fluid to flow from the first section into the second section. By adjusting the action of the pump appropriately, an effective hydraulic retention time may be achieved for fluid in the treatment unit as a whole, whereby biological oxygen demand in the fluid that enters and passes through the first section is reduced by bacteria resident in the first section, while bacteria in the second section nitrify the BOD reduced fluid that the second section receives from the first section. The fluid thereby digested and nitrified is pumped from the second section into the fluid in the vessel exterior to the treatment unit as described above.

In yet other embodiments of the system, a plurality of units may be daisy-chained, whereby an initial unit has an inlet for fluid from the vessel external to the unit. Each unit but the last in the chain has an outlet directing flow of fluid into an inlet in the next unit. Fluid is adjustably pumped from the outlet of the terminal unit into the fluid in the vessel external to the unit. Each of the units may aerate fluid and each has its own population of bacteria such that, with adjustment of the pump rate to achieve an appropriate effective hydraulic retention time, BOD decreases and nitrification increasingly occurs as the fluid passes from unit to unit until the digested and nitrified fluid is discharged into the fluid in the vessel external to the units.

In yet other embodiments, the outlet of an aerobic treatment unit or an aerobic treatment unit daisy chain may feed the inlet of an anaerobic container for fermentation of the fluid by anaerobic bacteria before the fluid is dispersed into the fluid in the vessel external to the treatment unit.

While the invention has been described with a certain degree of particularity, it should be recognized that elements thereof may be altered by persons skilled in the art without departing from the spirit and scope of the invention. Accordingly, the present invention is not intended to be limited to the specific forms set forth in this specification, but on the contrary, it is intended to cover such alternatives, modifications and equivalents as can be reasonably included within the scope of the invention. The invention is limited only by the claims herein and their equivalents.

I claim:

1. A wastewater treatment system, comprising:
a vessel containing a wastewater body comprising a liquid, the vessel having a first interior bottom;
a treatment unit disposed in the wastewater body at a processing height above the interior bottom of the vessel, the treatment unit comprising:
a container;
a unit liquid inlet disposed to receive the liquid into the container from the wastewater body;
an air diffuser within the container, the air diffuser operatively connected to a source of compressed gas containing oxygen;
a unit gas outlet opening outside the wastewater body;
a pump, the pump having a pump rate and comprising a pump inlet and a pump outlet, the pump inlet disposed within the liquid in the container and the pump outlet connecting to the wastewater body within the vessel outside the container; and
a substrate suitable to support bacterial growth.

2. The wastewater treatment system according to claim 1, wherein the substrate further comprises a population of activated treatment bacteria.

3. The wastewater treatment system according to claim 2, wherein the substrate is one of IFAS and MBBR.

4. The wastewater treatment system according to claim 1, wherein the liquid in the vessel contains sludge settled to a level proximate the first interior bottom and wherein the processing height is such that the unit liquid inlet is above the level of the sludge.

5. The wastewater treatment system according to claim 1, wherein the container has a second interior bottom, the liquid in the container contains sludge settled proximate the second interior bottom and the pump is further operative to deliver the sludge from the container to the wastewater body outside the container.

6. The wastewater treatment system according to claim 1, further comprising a means for adjusting the processing height.

7. The wastewater treatment system according to claim 1, wherein the container further comprises a liquid permeable wall dividing the liquid within the container into a first container section, proximal the unit liquid inlet, and a second container section in which is disposed the pump inlet, distal the unit liquid inlet.

8. The wastewater treatment system according to claim 1, wherein the pump is one of an air-operated pump, an electrically operated pump, a hydraulically operated pump and a pneumatically operated pump.

9. The wastewater treatment system according to claim 8, wherein the pump is air operated and is an intermittent air lift pump.

10. The wastewater treatment system according to claim 1, wherein the pump rate is user-adjustable.

11. The wastewater treatment system according to claim 1, the vessel further having an access opening, and wherein the container is dimensioned to fit through the access opening of the vessel.

12. The wastewater treatment system according to claim 11, wherein the container has a least dimension smaller than 24 inches.

13. The wastewater treatment system according to claim 1, in which the container is fabricated of flat sheet material.

14. A method for improved wastewater processing in a vessel configured to be filled with a liquid comprising wastewater to a vessel wastewater fill level, comprising:
inserting a treatment unit into the vessel, the treatment unit comprising a container having a unit liquid inlet;
disposing the treatment unit at an operational level with respect to the vessel wastewater fill level, whereby the liquid within the vessel outside the container may flow into the container through the unit liquid inlet;
filling the vessel with the liquid to the vessel wastewater fill level;
allowing the liquid to flow into the treatment unit through the unit liquid inlet;
providing compressed gas containing oxygen to the treatment unit;
aerating the liquid within the container with the compressed gas;
venting compressed gas from the container without aerating the liquid in the vessel outside the treatment unit; and
pumping the liquid at a pumping rate from within the container into the liquid in the vessel outside the container while allowing the liquid in the vessel outside the container to flow into the wastewater in the container through the unit liquid inlet.

15. The method for improved wastewater processing according to claim 14, further comprising setting the pumping rate.

16. The method for improved wastewater processing according to claim 15, wherein setting the pumping rate comprises setting a flow rate for the pumping.

17. The method for improved wastewater processing according to claim 15, wherein setting the pumping rate comprises setting a duty cycle for intermittently pumping the liquid.

18. The method for improved wastewater processing according to claim 14, further comprising dispersing compressed gas at a level above the vessel wastewater fill level.

19. A system for processing liquid containing wastewater, comprising:
a vessel comprising a body of liquid and further comprising an airspace above the body of liquid;
a plurality of treatment units in sequence, comprising at least an initial unit and a terminal unit, all disposed within the body of liquid, each treatment unit comprising a unit inlet and a unit outlet;
a liquid pathway from the vessel into the unit inlet of the initial unit, from the unit outlet of one unit into the unit inlet of each subsequent unit, and out of the unit outlet of the terminal unit into the vessel;
at least one pump having an operational rate and disposed within the liquid pathway, the at least one pump comprising a pump inlet proximal the unit inlet of the initial unit and a pump outlet proximal the unit outlet of the terminal unit;
and wherein at least one unit further comprises:
an air diffuser within the treatment unit, the air diffuser operatively connected to a source of compressed gas containing oxygen; and
a treatment unit gas outlet opening into the airspace of the vessel;
and wherein at least one unit comprises a substrate suitable to support microbial growth.

20. A system according to claim 19, wherein the operational rate of the at least one pump is user-controlled.
